(19) United States
(12) Patent Application Publication
(10) Pub. No.: US 2021/0044799 A1
(43) Pub. Date: Feb. 11, 2021

(54) ADAPTIVE RESOLUTION CHANGE IN VIDEO PROCESSING

(71) Applicant: ALIBABA GROUP HOLDING LIMITED, George Town (KY)

(72) Inventors: Jiancong LUO, San Mateo, CA (US); Yan YE, San Mateo, CA (US); Ruling LIAO, Beijing (CN); Jie CHEN, Beijing (CN)

(21) Appl. No.: 16/910,885

(22) Filed: Jun. 24, 2020

Related U.S. Application Data
(60) Provisional application No. 62/884,878, filed on Aug. 9, 2019.

(51) Int. Cl. H04N 19/117; H04N 19/80; H04N 19/132; H04N 19/105; H04N 19/30; H04N 19/513; H04N 19/176

(52) U.S. Cl. CPC H04N 19/117; H04N 19/80; H04N 19/132; H04N 19/176; H04N 19/30; H04N 19/513; H04N 19/105

(57) ABSTRACT

The present disclosure provides systems and methods for processing video content. The method can include: determining a fixed-phase interpolation filter for a block of a resampled reference picture; generating unrefined prediction samples of the block, by performing motion compensation on samples of the block using the fixed-phase interpolation filter; and encoding or decoding a target picture based on the unrefined prediction samples.

### CROSS REFERENCE TO RELATED APPLICATION

The disclosure claims the benefits of priority to U.S. Provisional Application No. 62/884,878, filed Aug. 9, 2019, which is incorporated herein by reference in its entirety.

### TECHNICAL FIELD

The present disclosure generally relates to video processing, and more particularly, to methods and systems for processing video content using adaptive resolution change (ARC).

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a computer-implemented method. The method can include: determining a fixed-phase interpolation filter for a block of a resampled reference picture; generating unrefined prediction samples of the block, by performing motion compensation on samples of the block using the fixed-phase interpolation filter; and encoding or decoding a target picture based on the unrefined prediction samples.

Embodiments of the present disclosure also provide a system for processing video content. The system can include: a memory storing a set of instructions; and at least one processor configured to execute the set of instruction to cause the system to perform: determining a fixed-phase interpolation filter for a block of a resampled reference picture; generating unrefined prediction samples of the block, by performing motion compensation on samples of the block using the fixed-phase interpolation filter; and encoding or decoding a target picture based on the unrefined prediction samples.

Embodiments of the present disclosure further provide a non-transitory computer readable medium that stores a set of instructions that is executable by at least one processor of a computer system to cause the computer system to perform a method for processing video content. The method can include: determining a fixed-phase interpolation filter for a block of a resampled reference picture; generating unrefined prediction samples of the block, by performing motion compensation on samples of the block using the fixed-phase interpolation filter; and encoding or decoding a target picture based on the unrefined prediction samples.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an exemplary video sequence, consistent with embodiments of the disclosure, consistent with embodiments of the disclosure.

FIG. 2A illustrates a schematic diagram of an exemplary encoding process of a hybrid video coding system, consistent with embodiments of the disclosure.

FIG. 2B illustrates a schematic diagram of another exemplary encoding process of a hybrid video coding system, consistent with embodiments of the disclosure.

FIG. 3A illustrates a schematic diagram of an exemplary decoding process of a hybrid video coding system, consistent with embodiments of the disclosure.

FIG. 3B illustrates a schematic diagram of another exemplary decoding process of a hybrid video coding system, consistent with embodiments of the disclosure.

FIG. 4 is a block diagram of an exemplary apparatus for encoding or decoding a video, consistent with embodiments of the disclosure.

FIG. 5 illustrates an exemplary decoded picture buffer, consistent with embodiments of the disclosure.

FIG. 6 illustrates an example of sub-block based translational motion and sample-based affine motion, consistent with embodiments of the disclosure.

FIG. 7 illustrates exemplary resampled sample positions after down-sampling and motion compensation, consistent with embodiments of the disclosure.

FIG. 8 illustrates an exemplary regular motion compensation process without down-sampling, consistent with embodiments of the disclosure.

FIG. 9 illustrates exemplary fixed phase resampled pixel position after down-sampling and motion compensation, consistent with embodiments of the disclosure.

FIG. 10 illustrates a flowchart of reusing the prediction refinement with optical flow (PROF) process for phase variant interpolation in RPR, consistent with embodiments of the disclosure.

FIG. 11 is a flowchart of an exemplary computer-implemented method for processing video content, consistent with embodiments of the disclosure.

FIG. 12 is a flowchart of a method for generating a final prediction sample based on an unrefined prediction sample, consistent with embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Video coding systems are often used to compress digital video signals, for instance to reduce storage space consumed or to reduce transmission bandwidth consumption associated with such signals. With high-definition (HD) videos (e.g., having a resolution of 1920×1080 pixels) gaining popularity in various applications of video compression, such as online video streaming, video conferencing, or video monitoring, it is a continuous need to develop video coding tools that can increase compression efficiency of video data.

For example, video monitoring applications are increasingly and extensively used in many application scenarios (e.g., security, traffic, environment monitoring, or the like), and the numbers and resolutions of the monitoring devices keep growing rapidly. Many video monitoring application scenarios prefer to provide HD videos to users to capture more information, which has more pixels per frame to capture such information. However, an HD video bitstream can have a high bitrate that demands high bandwidth for transmission and large space for storage. For example, a monitoring video stream having an average 1920×1080 resolution can require a bandwidth as high as 4 Mbps for real-time transmission. Also, the video monitoring generally monitors 7×24 continuously, which can greatly challenge a storage system, if the video data is to be stored. The demand for high bandwidth and large storage of the HD videos has therefore become a major limitation to its large-scale deployment in video monitoring.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for monitoring, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture coded using a previous picture as a reference picture is referred to as a “P-picture.” A picture coded using both a previous picture and a future picture as reference pictures (i.e., the reference is “bi-directional”) is referred to as a “B-picture.”

As previously mentioned, video monitoring that uses HD videos faces challenges of demands of high bandwidth and large storage. For addressing such challenges, the bitrate of the encoded video can be reduced. Among the I-, P-, and B-pictures, I-pictures have the highest bitrate. Because the backgrounds of most monitoring videos are nearly static, one way to reduce the overall bitrate of the encoded video can be using fewer I-pictures for video encoding.

However, the improvement of using fewer I-pictures can be trivial because the I-pictures are typically not dominant in the encoded video. For example, in a typical video bitstream, the ratio of I-, B-, and P-pictures can be 1:20:9, in which the I-pictures can account for less than 10% of the total bitrate. In other words, in such an example, even all I-pictures are removed, the reduced bitrate can be no more than 10%.

This disclosure provides methods, apparatuses, and systems for processing video content using adaptive resolution change (ARC). Unlike inaccurate phases caused by phase rounding, embodiments of the disclosure provide a pixel refinement process based on a fixed-phase interpolation to reduce the complexity of the algorithm and the hardware while maintain accuracy.

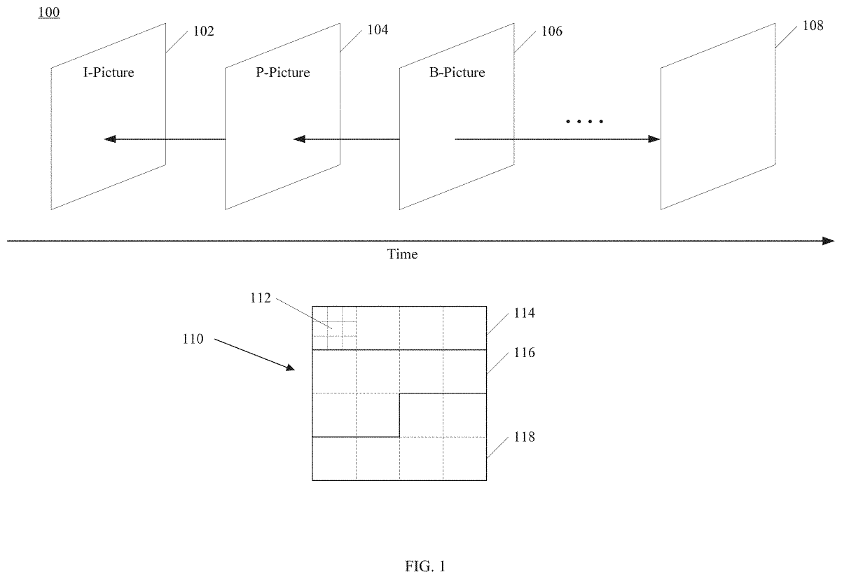

FIG. 1 illustrates structures of an exemplary video sequence 100, consistent with embodiments of the disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and this disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in this disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTB s”) in some video coding standards (e.g., H.265/HEVC or H.266/VVC). Any operation performed to a basic processing unit can be repeatedly performed to each of its luma and chroma components.

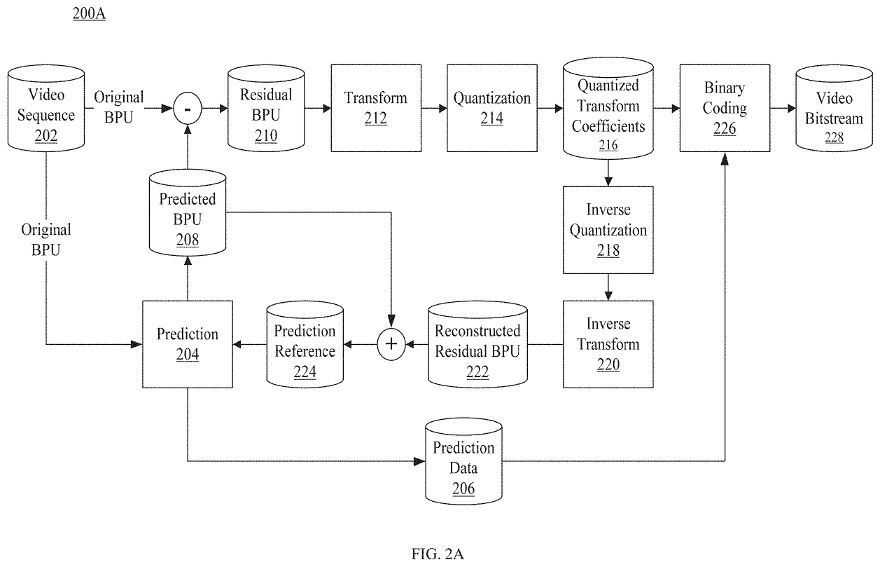

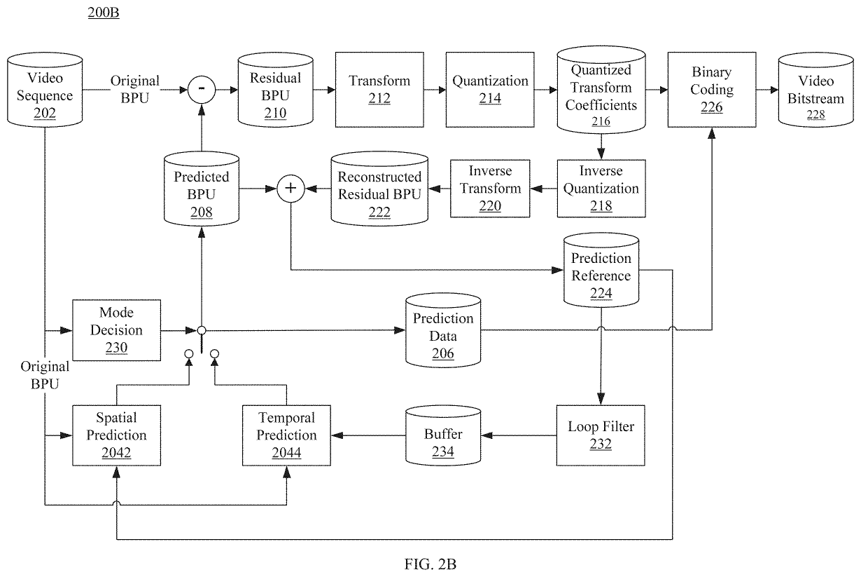

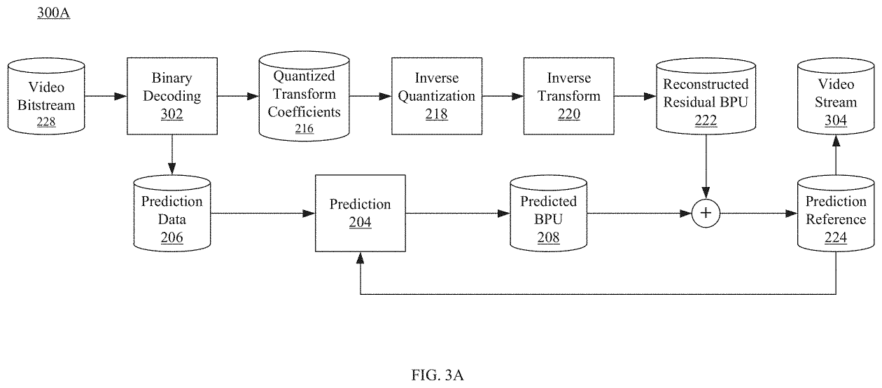

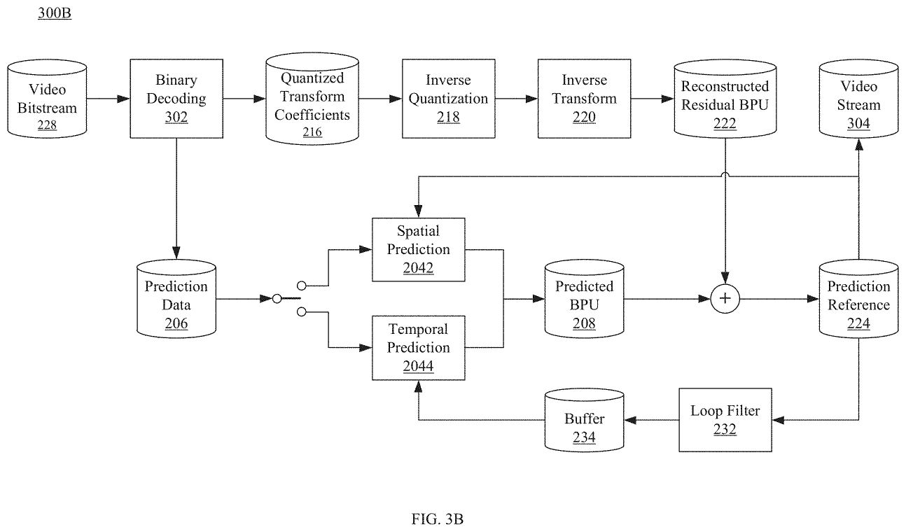

Video coding has multiple stages of operations, examples of which will be detailed in FIGS. 2A-2B and 3A-3B. For each stage, the size of the basic processing units can still be too large for processing, and thus can be further divided into segments referred to as “basic processing sub-units” in this disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which will be detailed in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which will be detailed in FIG. 2A), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which will be detailed in FIG. 2A), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and this disclosure does not limit embodiments thereof.

FIG. 2A illustrates a schematic diagram of an exemplary encoding process 200A, consistent with embodiments of the disclosure. An encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (i.e., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), the encoder can feed prediction reference 224 to loop filter stage 232, at which the encoder can apply a loop filter to prediction reference 224 to reduce or eliminate distortion (e.g., blocking artifacts) introduced by the inter prediction. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the encoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, when the prediction mode indicator of prediction data 206 indicates that inter prediction was used to encode the current BPU, prediction data can further include parameters of the loop filter (e.g., a loop filter strength).

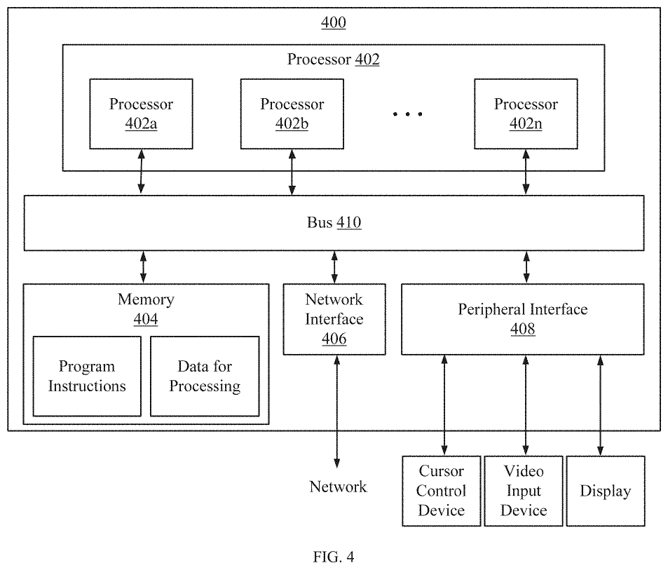

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

One of the requirements of the VVC standard is to offer video conferencing applications the ability to tolerate diversity of networks and devices, and to be able to rapidly adapt to varying network environments, including rapidly reducing encoded bit rate when network conditions deteriorate, and to rapidly increasing video quality when network conditions improve. The expected video quality may vary from very low to very high. The standard shall also support fast representation switching in the case of adaptive streaming services that offer multiple representations of the same content, each having different properties (e.g. spatial resolution or sample bit depth). During switching from one representation to another representation (such as switching from one resolution to another resolution), the standard shall enable the use of efficient prediction structure without compromising the fast and seamless switching capability.

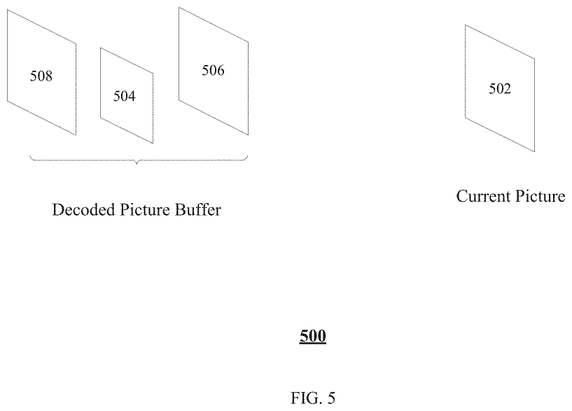

The adaptive resolution change (ARC) allows a stream to change spatial resolution between coded pictures within the same video sequence, without requiring a new IDR frame and without requiring multi-layers as in scalable video codec. The IDR frame can be used to specify that no frame after the IDR frame can reference any frame before it. Instead, at a switch point, pictures change resolution may be predicted from reference pictures of the same resolution (if available) and from reference pictures of a different resolution. For example, FIG. 5 illustrates an exemplary decoded picture buffer, consistent with embodiments of the disclosure. As shown in FIG. 5, the decoded picture buffer (DPB) can include a first reference picture 504, a second reference picture 506, and a third reference picture 508. Among these reference pictures, a resolution of second reference picture 506 is same as a current picture 502 but resolutions of reference pictures 504 and 508 are different from that of current picture 502. If a reference picture (e.g., reference picture 504 or 508) is of a different resolution, then the reference picture is resampled. After reference pictures 504 and 508 are resampled to the resolution of current picture 502, motion compensated prediction from these references may be performed. Hence, adaptive resolution change (ARC) is also sometimes referred to as reference picture resampling (RPR), and these two terms are used interchangeably in this disclosure

When the resolution of a reference picture is different from that of the current picture, a first way to generate the motion compensated prediction signal is picture-based resampling, where the reference picture is first resampled to the same resolution as the current picture, and the existing motion compensation process with motion vectors can be applied. For example, the picture-based resampling can include reference picture down-sampling, in which resolution of the reference picture is larger than that of the current picture. In some embodiments, the motion vectors may be scaled, if they are sent in units before resampling is applied. In some embodiment, the motion vectors may not be scaled, if they are sent in units after resampling is applied. With the picture-based resampling (e.g., reference picture down-sampling), information may be lost in the reference resampling step before the motion compensated interpolation, because downsamling is usually achieved with a low-pass filtering followed by decimation.

A second way to generate the motion compensated prediction signal is block-based resampling, where resampling is performed at a block level. The block-based resampling can include examining the reference picture(s) used by the current block, and resampling in combination with the sub-pel motion compensated interpolation process, if one or both of them have different resolutions than the current picture. Combining the resampling and motion compensated interpolation into one filtering operation may reduce the information loss mentioned above. Take the following case as an example: the motion vector of the current block has half-pel precision in one dimension, e.g., the horizontal dimension, and the reference picture's width is 2 times that of the current picture. In this example, compared to the picture-level resampling, which will reduce the width of the reference picture by half to match the width of the current picture, and then doing half-pel motion interpolation, the block-based resampling can directly fetch the odd positions in the reference pictures as the reference block at half-pel precision.

Prediction refinement with optical flow for affine mode will be discussed below.

Specifically, in some embodiments, a coding tool called prediction refinement with optical flow (PROF) has been adopted to improve the affine motion compensated prediction accuracy by refining the sub-block based affine motion compensated prediction with optical flow. Affine motion model parameters can be used to derive the motion vector of each sample position in a coding unit (CU). However, due to the high complexity and memory access bandwidth for generating sample-by-sample affine motion compensated prediction, the current VVC adopted a sub-block based affine motion compensation method, where a CU is divided into 4×4 sub-blocks, each of which is assigned a MV derived from the affine CU's control point MVs. The sub-block based affine motion compensation is a trade-off between coding efficiency, complexity and memory access bandwidth. It loses some prediction accuracy due to sub-block based prediction instead of the theoretical sample-based motion compensated prediction.

To achieve a finer granularity of affine motion compensation, PROF is applied after regular subblock based affine motion compensation. A sample-based refinement is derived based on the following Equation (1).

ΔI(i, j)=gₓ(i, j)*Δvₓ(i, j)+g_{y}(i, j)*Δv_{y}(i, j) (1)

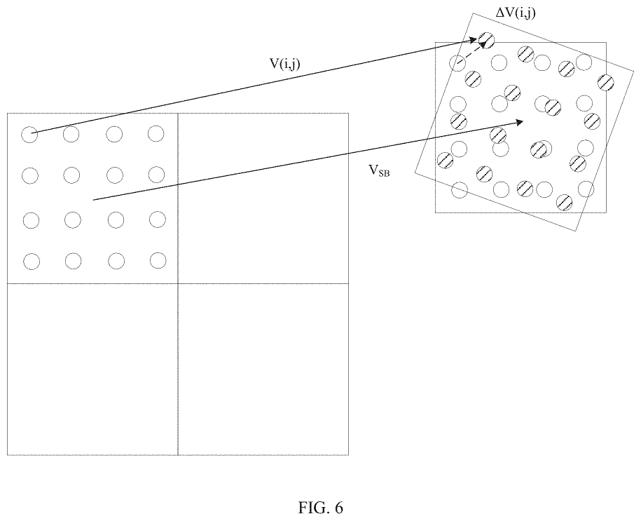

In the above Equation (1), gₓ(i, j) and g_{y}(i, j) is the spatial gradient at sample position (i, j). Δv is the motion offset from the sub-block based motion vector to the sample-based motion vector derived from the affine model parameters. FIG. 6 illustrates an example of sub-block based translational motion and sample-based affine motion, consistent with embodiments of the disclosure. In FIG. 6, V(i, j) is the theoretical motion vector for the sample position (i, j) derived using the affine model, V_{SB} is the subblock based motion vector, and ΔV(i,j) is the difference between V(i,j) and V_{SB} as depicted by the dotted arrow in FIG. 6.

Then, the prediction refinement ΔI(i, j) is added to the sub-block prediction I(i, j). The final prediction I′(i,j) is generated using the following Equation (2).

I′(i, j)=I(i, j)+ΔI(i, j) (2)

Block-based resampling that combining resampling and motion compensation interpolation may reduce the information loss due to cascaded operations performed in picture-based resampling. However, one of the problems in this block-based resampling is that the motion compensated interpolation process becomes phase-variant. For example, a phase of the interpolation filter can be different row-by-row and/or column-by-column. How frequently a phase of the interpolation filter changes for each sample position within a given block to be predicted depends on a number of factors, including the sub-pel precision of the resampling filters (e.g., ⅛-pel vs. 1/16-pel vs. 1/32-pel), the scaling ratio in each dimension (e.g., 2:1 or 1.5:1 or 3:1, etc), the block size, and the like. In regular, motion compensation, once a motion vector of a block is known, the phase filter can be determined based on the motion vector of the block. For example, if the motion vector is ½-pel precision, then the ½-pel interpolation filter is loaded to on-chip memory to perform motion compensation. And, if the motion is ¾-pel precision, then the ¾-pel interpolation filter is loaded to on-chip memory to perform motion compensation. Therefore, this phase-variant interpolation filter that is necessary for motion compensation in RPR would cause higher complexity than normal motion compensation, as the filter coefficients have to be reloaded more frequently for phase changes within a block, otherwise higher on-chip memory has to be provided to store all the interpolation filters for all the different phases that are needed by the current block. Not only does this increase hardware implementation complexity, similar complexity increase exists for software implementation too. For example, due to the fact that the neighboring samples can use different filter coefficients, the phase-variant interpolation filter is not SIMD friendly.

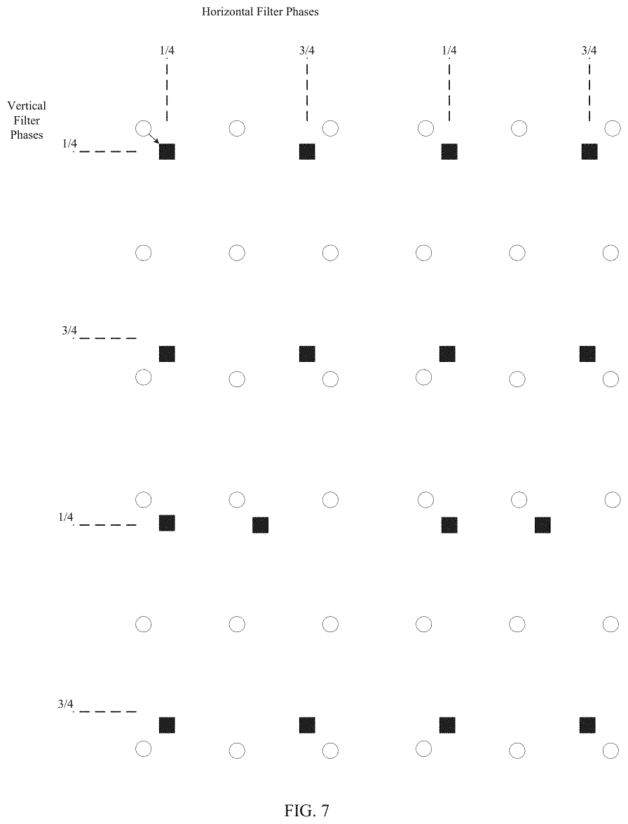

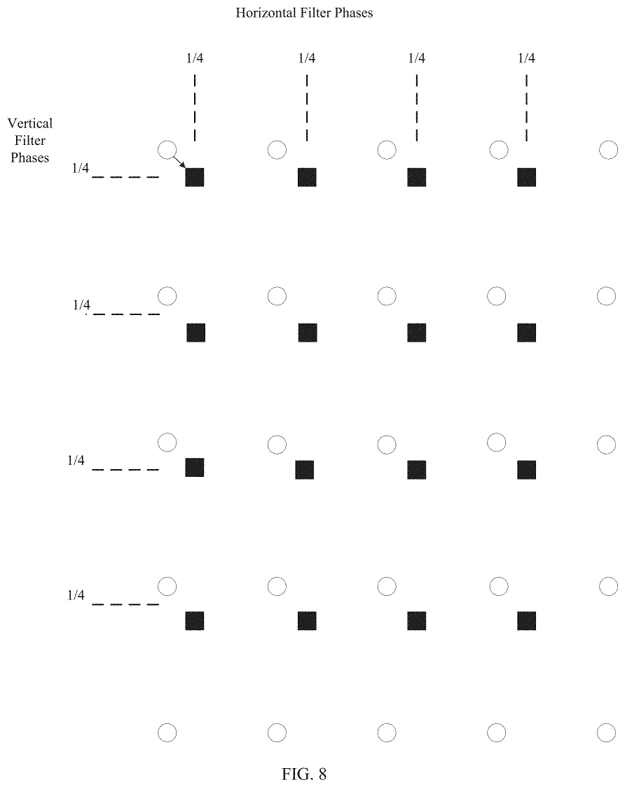

FIG. 7 shows the resampled sample positions when combining 1.5:1 down-sampling and motion compensation with motion vector (MV) (¼, ¼), consistent with embodiments of the disclosure. In FIG. 7, the white circles are the reference picture samples, and the black squares are the down-sampled pixel position. The horizontal phases and vertical phases are shown in the top and left of the graph, respectively. The interpolation filter phases are changed sample by sample, and filters corresponding to two phases. For example, ¼ and ¾ phases are needed to perform motion compensation. As a comparison, FIG. 8 illustrates a regular motion compensation process without down-sampling, consistent with embodiments of the disclosure. As shown in FIG. 8, the interpolation filter phase is fixed for the entire block. Note that this gives a simple example where the number of phases needed in a block is just 2. In some embodiments, the number of phases needed for a block may be much higher than 2, if other resampling ratios and/or different horizontal and vertical resampling ratios are used.

While the motion compensated interpolation combined with resampling is different with the existing phase-invariant motion compensated interpolation in VVC 5, additional hardware/software module may be required.

Embodiments of this disclosure provide methods and systems to remove the need for applying the phase-variant interpolation process, such that reference down-sampling and motion compensation can be combined into one filter. Thus, the disclosed methods and systems can reduce the hardware and software implementation complexity and reuse other existing modules in the VVC.

According to a first embodiment consistent with the present disclosure, the down-sampled pixel position can be rounded such that all sub-pel positions in the motion compensated block are the same and a phase-invariant filter can be used. One example of this embodiment is shown with reference to FIG. 8. In this example, the fixed filter phase is the sub-pel position of motion vector. However, rounding the resampled pixel position may cause quality degradation in the prediction, as the prediction signal thus obtained can no longer represent the actual phase of each sample position correctly.

In order to correct the inaccurate phases for some sample positions due to phase rounding, in another embodiment of this disclosure, a pixel refinement process is applied following the phase-invariant interpolation to rectify artifacts caused by the pixel rounding. The pixel refinement process can be performed in two steps.

In a first step, the unrefined prediction is generated by performing motion compensation on the (resampled) reference picture with a fixed phase interpolation filter. For example, the phase of the fixed-phase horizontal interpolation filter may be determined by the fractional component of the horizontal motion vector, and the phase of the fixed-phase vertical interpolation filter may be determined by the fractional component of the vertical motion vector. An example is shown in FIG. 8. Alternatively, the phase of the fixed-phase horizontal interpolation filter may be determined by the most dominant phase (that is, most probable phase) in the horizontal dimension in the block, and similarly for the fixed-phase filter in the vertical direction.

In a second step, the final phase corrected prediction is generated by adding to the unrefined prediction (e.g., prediction generated by fixed-phase filters) a sampled-based refinement derived based on the optical flow. The detail of the second step can include the following sub-steps.

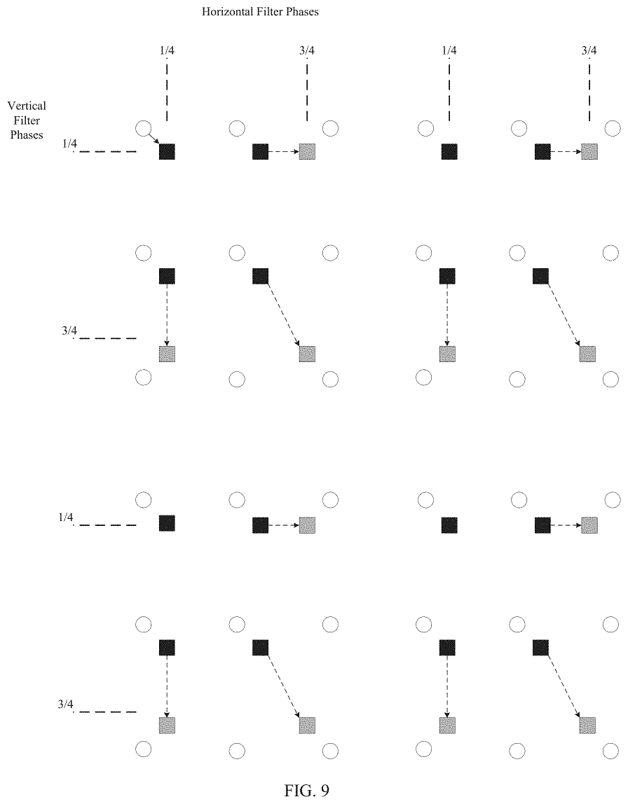

In a first sub-step, an optical flow can be calculated using Δv(i, j)=(Δvₓ(i, j), Δv_{y}(i, j)). Δv is an offset from the shifted resampled position of pixel (i, j) to the original resampled position of pixel (i, j), as shown by the dash arrows in FIG. 9.

In a second sub-step, gradients of the unrefined prediction samples can be calculated. Let horizontal and vertical gradients of unrefined prediction samples be gₓ and g_{y}, respectively. An exemplary gradient calculation is shown below.

gₓ(i, j)=(P(i+1, j)−P(i−1, j))/2 (3)

g_{y}(i, j)=(P(i, j+1)−P(i, j−1))/2 (4)

In the above Equations (3)-(4), a simple subtraction of neighboring sample values is used to derive the gradient. To a person skilled in the art, other more complicated gradient filters can also be used to derive gₓ(i, j) and g_{y}(i, j).

In a third sub-step, the sample-based refinement can be calculated using the following Equation (5) below.

ΔP(i, j)=gₓ(i, j)*Δvₓ(i, j)+g_{y}(i, j)*Δv_{y}(i, j) (5)

In a fourth sub-step, the final phase corrected prediction can be obtained by combining the unrefined prediction and the sample-base refinement.

Comparing to the phase-variant interpolation filter that used to combine the reference down-sampling and motion compensation, the first embodiment uses phase-invariant filters to reduce the complexity. The second embodiment further refines the resampled sample to reduce the precision lost caused by the phase shifting.

While PROF is applied on affine CU and Δv is derived from the affine model parameters, some embodiments of the disclosure apply the refinement derived by the optical flow equation on a resampled block and the Δv is derived by the resampling ratio. The major difference is the derivation of Δv. Other parts of the process may be shared. Being able to reuse part of the process is beneficial to the hardware implementation.

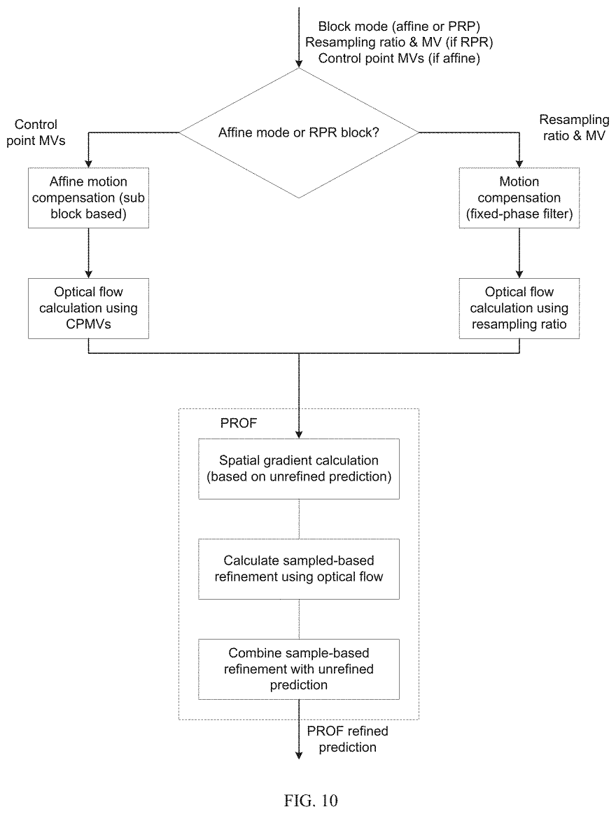

FIG. 10 illustrates a flowchart of reusing the PROF process for phase variant interpolation in RPR, consistent with embodiments of the disclosure. In other words, the existing PROF process may be shared between the affine predicted CUs and the block-based ARC-predicted CUs that need phase-variant interpolation filters. As shown in FIG. 10, the PROF process may be shared between these two kinds of CUs with unified input and output interfaces, and what is different may be the specific values of the input parameters and the output refined prediction signal. In terms of the value of the optical flow Δv(i, j)=(Δvₓ(i, j), Δv_{y}(i, j)), it is noted that in the case of affine predicted CUs, Δv(i, j) is calculated based on the control point MVs of the affine CU, so the x and y components, Δvₓ(i, j) and Δv_{y}(i, j), may have relatively large values (e.g., larger than 1 luma sample). In contrast, in the case of ARC predicted CU, Δvₓ(i, j) and Δv_{y}(i, j) only represent the difference in filter phases measured by fractional samples. Therefore, their magnitudes are smaller than 1 luma sample. Considering this difference, the PROF process may be programmed to apply different precisions depending on whether a CU is affine predicted or ARC predicted, for example, the internal precision of the PROF process may be higher for the ARC-predicted CUs.

In the case of the affine predicted CUs, the PROF process is only applied to luma prediction. This is similar to the Bi-directional Optical Flow (BDOF) process in VVC. For the ARC-based PROF, both luma and chroma prediction can use phase-variant interpolation filters to generate the prediction signal with combined resampling and motion compensation interpolation. In some embodiments, the PROF is applied to luma and chroma prediction for ARC-predicted CUs. Alternatively, in some embodiments, in order to unify the design for affine-predicted blocks and ARC-predicted blocks, the PROF is only applied to the luma prediction signal for ARC-predicted blocks as well. In this case, computation complexity may be reduced because chroma prediction only needs fixed-phase filters. Although this creates some mismatch, the quality degradation may be limited because the chroma signal is generally smoother than the luma signal, and because the magnitudes of the optical flow are small in the case of ARC-predicted CUs (e.g., less than 1 luma sample).

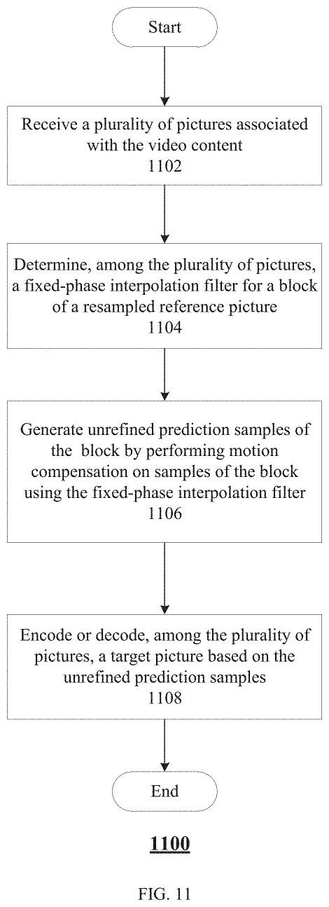

FIG. 11 is a flowchart of a computer-implemented method 1100 for processing video content using adaptive resolution change (ARC), according some embodiments of the disclosure.

In some embodiments, method 1100 can be performed by a codec (e.g., an encoder using encoding processes 200A and 200B of FIGS. 2A-2B or a decoder using decoding processes 300A and 300B of FIGS. 3A-3B). For example, the codec can be implemented as one or more software or hardware components of an apparatus (e.g., apparatus 400) for encoding or transcoding a video sequence. In some embodiments, the video sequence can be an uncompressed video sequence (e.g., video sequence 202) or a compressed video sequence that is decoded (e.g., video stream 304). In some embodiments, the video sequence can be a monitoring video sequence, which can be captured by a monitoring device (e.g., the video input device in FIG. 4) associated with a processor (e.g., processor 402) of the apparatus. The video sequence can include multiple pictures. The apparatus can perform method 1100 at the level of pictures. For example, the apparatus can process one picture at a time in method 1100. For another example, the apparatus can process a plurality of pictures at a time in method 1100. Method 1100 can include steps as below.

At step 1102, a plurality of pictures associated with the video content can be received. As discussed above, the plurality of pictures can include pictures in the decoded picture buffer (DPB) (e.g., a first reference picture 504, a second reference picture 506, and a third reference picture 508 of FIG. 5) and a current picture 502 of FIG. 5.

At step 1104, among the plurality of pictures, a fixed-phase interpolation filter can be determined for a block of a resampled reference picture. The resampled reference picture can be one of the pictures in the DPB (e.g., first reference picture 504, second reference picture 506, or third reference picture 508). The fixed-phase interpolation filter can include a fixed-phase horizontal interpolation filter and a fixed-phase vertical interpolation filter. A phase of the fixed-phase interpolation filter can be a sub-pixel position of a motion vector of the block, and the phase of the fixed-phase interpolation filter includes a horizontal phase and a vertical phase. As discussed above, the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block. Alternatively, the horizontal phase of the fixed-phase horizontal interpolation filter is a most dominant horizontal phase in a horizontal dimension of the block, and the vertical phase of the fixed-phase vertical interpolation filter is a most dominant vertical phase in a vertical dimension of the block.

At step 1106, unrefined prediction samples of the block can be generated by performing motion compensation on samples of the block using the fixed-phase interpolation filter.

At step 1108, among the plurality of pictures, a target picture can be encoded or decoded based on the unrefined prediction samples. In some embodiments, encoding or decoding the target picture based on the unrefined prediction samples can further include: generating final prediction samples based on the unrefined prediction samples of the block; and encoding or decoding the target picture based on the final prediction samples.

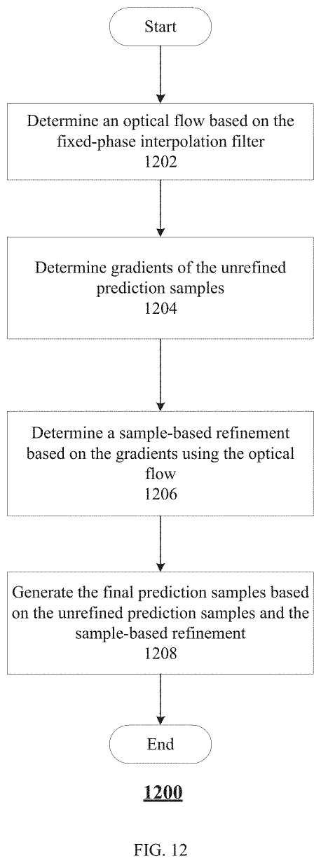

In some embodiments, a method for generating a final prediction sample based on an unrefined prediction sample can be provided. FIG. 12 is a flowchart of a method 1200 for generating a final prediction sample based on an unrefined prediction sample, consistent with embodiments of the disclosure. Method 1200 can be implemented independently or as part of method 1100. Method 1200 can include steps as below.

At step 1202, an optical flow of an unrefined prediction sample can be determined based on the fixed-phase interpolation filter. The optical flow reflect an offset from a shifted resampled position of a pixel to an original resampled position of the same pixel (e.g., dash arrows of FIG. 9). The optical flow can include a horizontal optical flow and a vertical optical flow.

At step 1204, a gradient of the unrefined prediction sample can be determined. A gradient can include a horizontal gradient and a vertical gradient, and can be determined based on positions of two neighboring pixels of the unrefined prediction sample.

At step 1206, a sample-based refinement of the unrefined prediction sample can be determined based on the gradient using the optical flow. For example, the sample-based refinement can be calculated by multiplying the gradient and the optical flow.

At step 1208, a final prediction sample can be generated based on the unrefined prediction sample and the sample-based refinement. For example, the final prediction sample can be generated by adding the unrefined prediction sample and the sample-based refinement.

The generated final prediction samples can be used to encode or decode the target picture.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The embodiments may further be described using the following clauses:

1. A computer-implemented method, comprising:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

2. The method according to clause 1, wherein encoding or decoding the target picture based on the unrefined prediction samples further comprises:
generating final prediction samples based on the unrefined prediction samples; and
encoding or decoding the target picture based on the final prediction samples.

3. The method according to clause 2, wherein generating the final prediction samples based on the unrefined prediction samples comprises:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

4. The method according to any one of clauses 1-3, wherein the fixed-phase interpolation filter further comprises a fixed-phase horizontal interpolation filter and a fixed-phase vertical interpolation filter.

5. The method according to clause 4, wherein a phase of the fixed-phase interpolation filter is a sub-pixel position of a motion vector associated with the block, and the phase of the fixed-phase interpolation filter comprises a horizontal phase and a vertical phase.

6. The method according to clause 5, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.

7. The method according to clause 5 or 6, wherein the horizontal phase of the fixed-phase horizontal interpolation filter is a most dominant horizontal phase in a horizontal dimension of the block, and the vertical phase of the fixed-phase vertical interpolation filter is a most dominant vertical phase in a vertical dimension of the block.

8. A system for processing video content using adaptive resolution change (ARC), comprising:
a memory storing a set of instructions; and
at least one processor configured to execute the set of instruction to cause the system to perform:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

9. The system according to clause 8, wherein in encoding or decoding the target picture based on the unrefined prediction samples, the set of instructions is execute to cause the system to perform:
generating final prediction samples based on the unrefined prediction samples; and
encoding or decoding the target picture based on the final prediction samples.

10. The system according to clause 9, wherein in generating the final prediction samples based on the unrefined prediction samples, the set of instructions is execute to cause the system to perform:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

11. The system according to any one of clauses 8-10, wherein the fixed-phase interpolation filter further comprises a fixed-phase horizontal interpolation filter and a fixed-phase vertical interpolation filter.

12. The system according to clause 11, wherein a phase of the fixed-phase interpolation filter is a sub-pixel position of a motion vector associated with the block, and the phase of the fixed-phase interpolation filter comprises a horizontal phase and a vertical phase.

13. The system according to clause 12, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.

14. The system according to clause 12 or 13, wherein the horizontal phase of the fixed-phase horizontal interpolation filter is a most dominant horizontal phase in a horizontal dimension of the block, and the vertical phase of the fixed-phase vertical interpolation filter is a most dominant vertical phase in a vertical dimension of the block.

15. A non-transitory computer readable medium that stores a set of instructions that is executable by at least one processor of a computer system to cause the computer system to perform a method for processing video content using adaptive resolution change (ARC), the method comprising:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

16. The non-transitory computer readable medium according to clause 15, wherein encoding or decoding the target picture based on the unrefined prediction samples further comprises:
generating final prediction samples based on the unrefined prediction samples; and
encoding or decoding the target picture based on the final prediction samples.

17. The non-transitory computer readable medium according to clause 16, wherein generating the final prediction samples based on the unrefined prediction samples comprises:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

18. The non-transitory computer readable medium according to any one of clauses 15-17, wherein the fixed-phase interpolation filter further comprises a fixed-phase horizontal interpolation filter and a fixed-phase vertical interpolation filter.

19. The non-transitory computer readable medium according to clause 18, wherein a phase of the fixed-phase interpolation filter is a sub-pixel position of a motion vector of the block, and the phase of the fixed-phase interpolation filter comprises a horizontal phase and a vertical phase.

20. The non-transitory computer readable medium according to clause 19, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A computer-implemented method, comprising:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

2. The method according to claim 1, wherein encoding or decoding the target picture based on the unrefined prediction samples further comprises:
generating final prediction samples based on the unrefined prediction samples; and
encoding or decoding the target picture based on the final prediction samples.

3. The method according to claim 2, wherein generating the final prediction samples based on the unrefined prediction samples comprises:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

4. The method according to claim 1, wherein the fixed-phase interpolation filter further comprises a fixed-phase horizontal interpolation filter and a fixed-phase vertical interpolation filter.

5. The method according to claim 4, wherein a phase of the fixed-phase interpolation filter is a sub-pixel position of a motion vector associated with the block, and the phase of the fixed-phase interpolation filter comprises a horizontal phase and a vertical phase.

6. The method according to claim 5, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.

7. The method according to claim 5, wherein the horizontal phase of the fixed-phase horizontal interpolation filter is a most dominant horizontal phase in a horizontal dimension of the block, and the vertical phase of the fixed-phase vertical interpolation filter is a most dominant vertical phase in a vertical dimension of the block.

8. A system for processing video content using adaptive resolution change (ARC), comprising:
a memory storing a set of instructions; and
at least one processor configured to execute the set of instruction to cause the system to perform:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

9. The system according to claim 8, wherein in encoding or decoding the target picture based on the unrefined prediction samples, the set of instructions is execute to cause the system to perform:
generating final prediction samples based on the unrefined prediction samples; and
encoding or decoding the target picture based on the final prediction samples.

10. The system according to claim 9, wherein in generating the final prediction samples based on the unrefined prediction samples, the set of instructions is execute to cause the system to perform:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

11. The system according to claim 8, wherein the fixed-phase interpolation filter further comprises a fixed-phase horizontal interpolation filter and a fixed-phase vertical interpolation filter.

12. The system according to claim 11, wherein a phase of the fixed-phase interpolation filter is a sub-pixel position of a motion vector associated with the block, and the phase of the fixed-phase interpolation filter comprises a horizontal phase and a vertical phase.

13. The system according to claim 12, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.

14. The system according to claim 12, wherein the horizontal phase of the fixed-phase horizontal interpolation filter is a most dominant horizontal phase in a horizontal dimension of the block, and the vertical phase of the fixed-phase vertical interpolation filter is a most dominant vertical phase in a vertical dimension of the block.

15. A non-transitory computer readable medium that stores a set of instructions that is executable by at least one processor of a computer system to cause the computer system to perform a method for processing video content using adaptive resolution change (ARC), the method comprising:
determining a fixed-phase interpolation filter for a block of a resampled reference picture;
generating unrefined prediction samples of the block, by performing motion compensation on samples of the block using the fixed-phase interpolation filter; and
encoding or decoding a target picture based on the unrefined prediction samples.

16. The non-transitory computer readable medium according to claim 15, wherein encoding or decoding the target picture based on the unrefined prediction samples further comprises:
generating final prediction samples based on the unrefined prediction samples; and
encoding or decoding the target picture based on the final prediction samples.

17. The non-transitory computer readable medium according to claim 16, wherein generating the final prediction samples based on the unrefined prediction samples comprises:
determining an optical flow of an unrefined prediction sample based on the fixed-phase interpolation filter;
determining a gradient of the unrefined prediction sample;
determining a sample-based refinement based on the gradient using the optical flow; and
generating a final prediction sample based on the unrefined prediction sample and the sample-based refinement.

18. The non-transitory computer readable medium according to claim 15, wherein the fixed-phase interpolation filter further comprises a fixed-phase horizontal interpolation filter and a fixed-phase vertical interpolation filter.

19. The non-transitory computer readable medium according to claim 18, wherein a phase of the fixed-phase interpolation filter is a sub-pixel position of a motion vector of the block, and the phase of the fixed-phase interpolation filter comprises a horizontal phase and a vertical phase.

20. The non-transitory computer readable medium according to claim 19, wherein the horizontal phase of the fixed-phase horizontal interpolation filter is determined according to a fractional component of a horizontal motion vector associated with the block, and the vertical phase of the fixed-phase vertical interpolation filter is determined based on a fractional component of a vertical motion vector associated with the block.
